(19) United States
(12) Patent Application Publication
(10) Pub. No.: US 2007/0127351 A1
(43) Pub. Date: Jun. 7, 2007

(54) Optical disk device, semiconductor laser drive device and optical pickup device

(76) Inventor: Akio Fukushima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/486,215

(22) Filed: Jul. 14, 2006

(30) Foreign Application Priority Data
Dec. 1, 2005 (JP) 2005-347419

(51) Int. Cl. G11B 7/00

(52) U.S. Cl. 369/116

(57) ABSTRACT

Provided is a device which can reduce waveform distortion of a laser drive signal caused by impedance mismatching between a laser drive device and a semiconductor laser over a wide band, and which can enhance the power efficiency of higher frequency superposition during reproduction. The output impedance of the laser drive device and the line impedance of a transmission line between the laser drive device and the semiconductor laser are controlled so as to attain impedance matching in a predetermined frequency band. Specifically, the laser drive device is provided thereto with an output impedance control circuit for controlling the output impedance in order to change the impedance of a laser drive device output terminal, depending upon an impedance of the semiconductor laser and an impedance of the transmission line.

### INCORPORATION BY REFERENCE

The present application claims priority from Japanese application JP2005-347419 filed on Dec. 1, 2005, the content of which is hereby incorporated by reference into this application.

### BACKGROUND OF THE INVENTION

The present invention relates to an optical pickup device emitting a laser beam so as to carry out recording and reproduction onto and from an optical disk, a semiconductor laser drive device used in the optical pickup device, and an optical disk device using the above-mentioned devices, for carrying out recording and reproduction onto and from an optical disk.

A laser drive device has a laser current output circuit which outputs a modulated laser current for changing the state of a recording layer of an optical disk by energy of a laser beam emitted from an optical pickup in order to record data onto an optical disk.

Further, when data is reproduced from the optical disk, the laser drive device has a high-frequency superposing circuit for modulating the laser beam at a high frequency so as to reduce a light intensity fluctuation (laser noise) caused by interference between an optical feed back to the laser, and an emergent light beam from the laser.

JP-A-2004-281975 and JP-A-2003-229640 disclose impedance matching between a laser and a laser drive circuit. Further, JP-A-2005-268659 discloses impedance matching between an LD (laser diode) modulation signal generating portion and an LD drive portion.

### SUMMARY OF THE INVENTION

A bit rate for data recorded by an optical disk device varies depending upon a kind of an optical disk, a recording speed, and a modulation frequency of a laser modulating circuit ranges from about 1 to 200 MHz. When a waveform of a signal for driving the laser is distorted so as to affect a laser current, the energy of the emitter laser beam varies, resulting in detrimental affection upon data recorded on the optical disk. Thus, it is required to reduce occurrence of waveform distortion of the laser drive signal as far as possible.

Referring to FIG. 1 which is a block diagram illustrating a laser emitting circuit portion 20 of an optical pickup in a conventional optical disk device, the laser emitting circuit portion 20 is composed of a laser drive device 1 and a semiconductor laser 3 which are electrically connected to each other by means of a flexible circuit substrate located on an outer surface of the optical pickup. In the optical disk device, since the data bit rate for recoding data on an optical disk is lower so that a rise-up time Tr and a fall time Tf of a laser modulation signal are about several ns, a transmission line length of several ten mm between the laser drive device and the semiconductor laser on the optical pickup is sufficiently short in comparison with a wavelength corresponding to a transmission signal frequency of a laser modulation signal, and accordingly, affection by a characteristic impedance of the transmission line had been substantially negligible.

Referring to FIG. 2 which shows a high frequency equivalent circuit of a conventional semiconductor laser 3, the high frequency equivalent circuit is composed of a parallel circuit between a resistance rd having several to several ten ohms and a capacitance Cs having several to several ten pF, and an inductance Ls having several nH connected in series to the parallel circuit. Since the affection by the inductance Ls and the capacitance Cs is less, the semiconductor laser may be substantially regarded as the resistance element rd in the case of laser modulation upon recording. Thus, in a circuit design between the laser drive device 1 and the semiconductor laser 3, the semiconductor laser 3 having a low impedance is driven by a high impedance power source. Thus, there have been less considered impedance matching therebetween.

The data bit rate with which data is recorded is higher and higher due to enhancement of a recording speed of an optical disk device and a proposal for a standard of new optical disks. For example, there is presented a device for recording data at a speed which is sixteen times as high as a standard speed, for DVD (digital versatile disc), and in this case, the upper limit of frequency spectrum of a laser drive signal exceeds 60 MHz. Further, recording is made at a speed which is twelve times as high as the standard speed, for Blu-ray which is now on study phase, and in this case, the upper limit of frequency spectrum of a laser drive signal exceeds 200 MHz. In order to transmit such high frequency signals, it is required to set even the laser modulation signals Tr, Tf to values which are not greater than 1 ns, and accordingly, the transmission frequency band ranges from 100 MHz to 1 GHz. Thus, in order to transmit the laser drive signal with low distortion, it is required to reduce waveform distortion due to reflection, disturbance in frequency characteristics and the like which are caused by impedance mismatching. Thus, it is required to carry out impedance matching among the laser drive device 1, the transmission line 2 and the semiconductor laser 3.

Since the laser, the laser current output circuit and the high frequency superposing circuit are either operated at high frequencies, impedance matching are required thereamong.

Further, the modulation frequency of the high frequency superposing circuit is set so as to be high in order to prevent affection upon a reproduction signal, that is, it is in general set in a range from 300 to 500 MHz. Since a power required for obtaining an emitted laser beam having a desired modulation degree is desirably set to a low value in the high frequency superposing circuit, it is required to efficiently transmit a high frequency power to the semiconductor laser. However, the impedance matching to the semiconductor laser 3 has been less considered in a design of the laser drive device 1 although an inductance Ls and capacitance are not negligible in the high frequency equivalent circuit of the semiconductor laser 3, and accordingly, there has been merely made such a design that a high frequency signal level has been set so as to supply a sufficient high frequency power to the semiconductor laser 3. However, the consideration for the high frequency superposition has been more and more changed, and accordingly, in order to obtain a desired modulation degree with a high frequency power which is as small as possible, there has been such a demand that the impedance matching has been made for efficiently transmitting a high frequency signal from the laser drive device 1 to the semiconductor laser 3.

Accordingly, the laser drive device having the laser current output circuit and a high frequency superposing circuit should be driven with a low waveform distortion and a lower power loss over a wide band from 1 to 500 MHz.

Thus, in view of the above-mentioned requisites, the present invention is to provide the following method in order to solve the problems. That is, an object of the present invention is to control the output impedance of the laser drive device and the line impedance of the signal transmission line between the laser drive device and the semiconductor laser so as to aim at making impedance matching in a predetermined frequency band, in order to reduce waveform distortion and lower power loss caused by impedance mismatching. Specifically, the signal transmission line is made in the form of a microstrip line for controlling the line impedance. Further, the laser drive device is provided with an impedance control circuit for controlling the output impedance so as to control the output impedance of the laser drive device in accordance with an impedance of the semiconductor laser and an impedance of the transmission line.

Thus, the impedance matching from the laser drive device to the semiconductor laser is improved so as to reduce waveform distortion of laser drive signals in order to aim at enhancing the recording quality, and to improve the high frequency superposing power efficiency in order to reduce power consumption.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating a configuration of a laser drive device and a semiconductor laser in a conventional optical device;

FIG. 2 is a view illustrating a high frequency equivalent circuit of a conventional semiconductor laser;

FIG. 3 is a block diagram illustrating a configuration of a laser drive device, a transmission line and a semiconductor laser in an optical disk device in a first embodiment of the present invention;

FIG. 4 is a block diagram illustrating a laser drive device in an embodiment of the present invention;

FIG. 5 is a block diagram illustrating a configuration of an impedance control circuit in the first embodiment of the present invention;

FIG. 6 is a block diagram illustrating a configuration of an impedance control circuit in a second embodiment of the present invention;

FIG. 7 is a block diagram illustrating a configuration of an optical disk device in an embodiment of the present invention;

FIG. 8 is a block diagram illustrating a laser drive device in an embodiment of the present invention; and

FIG. 9 is a block diagram illustrating a laser drive device in an embodiment of the present invention.

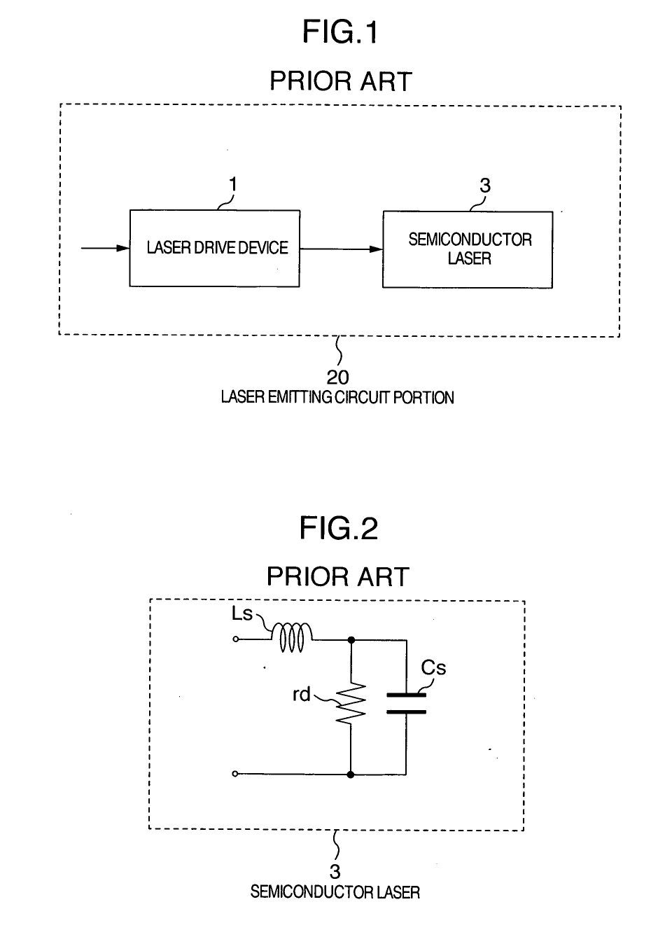

### DETAILED DESCRIPTION OF THE EMBODIMENTS

Explanation will be hereinbelow made of embodiments of the present invention with reference to the accompanying drawings.

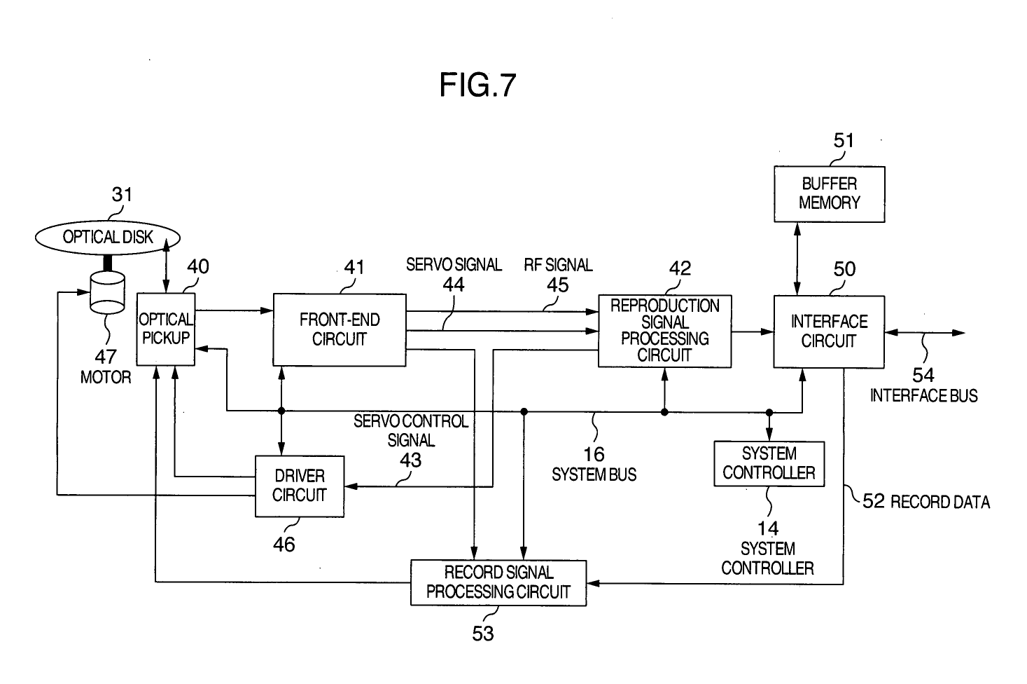

Referring to 7 which is a block diagram illustrating an entire configuration of an optical disk device applied therein with the present invention, the optical disk device incorporates a optical disk 31, an optical pickup 40, a front-end circuit 41, a reproduction signal processing circuit 42, a driver circuit 46, a motor 47, an interface circuit 50, a buffer memory 51, a record signal processing circuit 53, an interface bus 54, a system controller 14 and a system bus 16. Further, referring to FIG. 7, as main signals which are transmitted through this optical disk device, there are shown a servo control signal 43, a serve signal 44, an RF signal 45 and a recording data 52.

The optical pick-up 40 includes therein a laser emitting circuit portion which is essential in the present invention.

### Embodiment 1

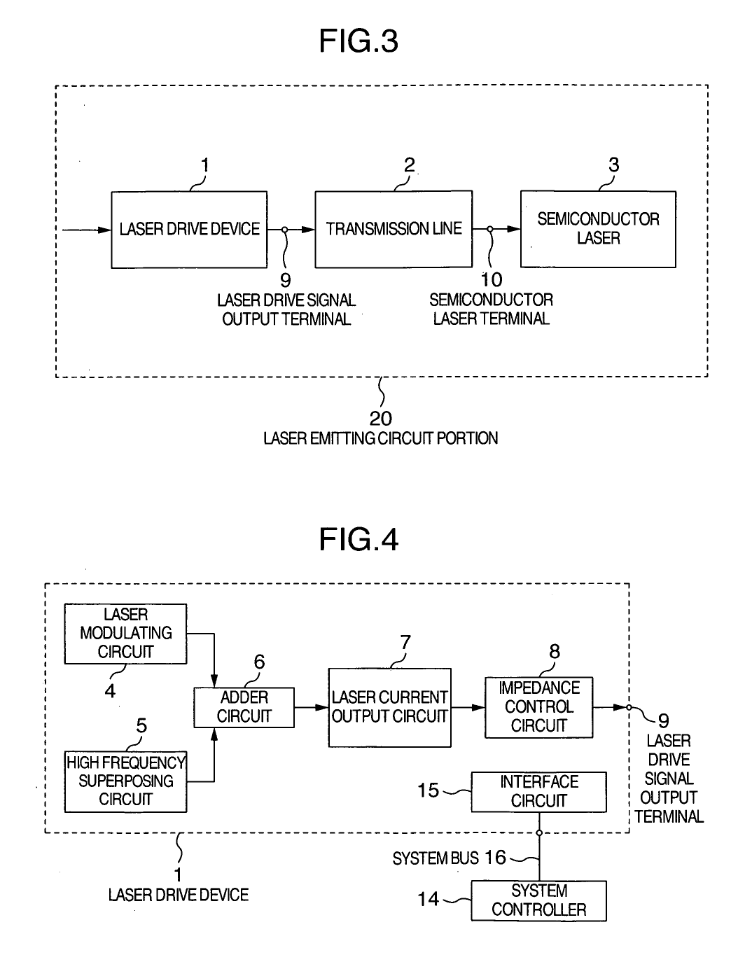

A first embodiment of the present invention will be explained with reference to FIG. 3.

Referring to FIG. 3 which is a block diagram illustrating a laser emitting circuit portion in an optical pickup in an optical disk device according to the present invention, the laser emitting circuit portion is composed of a laser drive device 1, a transmission line 2 and a semiconductor laser 3, which are electrically connected with one another by signal lines in a flexible print circuit board arranged on an outer surface of the optical pickup. The transmission line 2 is adapted to feed a laser drive signal outputted from the laser drive device 1, to the semiconductor laser 3. The transmission line 2 is a signal wiring part between a laser drive signal output terminal 9 of the laser drive device 1 and a semiconductor laser terminal 10 of the semiconductor laser 3.

Referring to FIG. 4 which is a block diagram illustrating a configuration of a laser drive device in an embodiment of the present invention, the laser drive device is in the form of an LSI (Large Scale Integration), that is, it is formed into a single package, incorporating therein a laser modulation circuit, a high frequency superposing circuit, an adder circuit, a laser current output circuit, an impedance control circuit and an interface circuit.

The laser drive circuit 4 is adapted to output a predetermined laser drive current with a predetermined timing in accordance with a length of a record mark and lengths of spaces before and after the record mark in order to record a predetermine mark on the optical disk, and carries out a write strategy generating process and control for turning on and off a plurality of current switches in accordance with the write strategy. Since the write strategy is not directly related to the present invention, explanation thereof will be abbreviated. Further, although a certain laser drive device (LSI) has not a write strategy generating function, the presence of the write strategy generating function is not essential in the present invention.

As stated above, in order to reduce variation (laser noise) in light intensity due to interference between a return light beam (optical feed back) toward the laser and an emergent light beam from the laser, the high frequency superposing circuit 5 modulates a light quantity of a laser beam during reproduction with a high frequency signal so as to oscillate the semiconductor laser in a multi mode, thereby it is possible to restrain interference between a return light beam and an emergent light beam. Accordingly, the function thereof is such that a high frequency signal having a predetermined frequency is delivered with a predetermined timing at a predetermined signal level.

The adder circuit 6 adds output signals delivered respectively from the laser modulating circuit 4 and the high frequency superposing circuit 5 to each other in order to produce an input signal to the laser current output circuit 7.

The laser current output circuit 7 has at least a current amplifying function for feeding a laser drive current corresponding to an output signal from the above-mentioned adder circuit 6, to the semiconductor laser. The purpose of the provision of the laser current output circuit 7 is to supply a predetermined current to a load, irrespective of states of the transmission line and the semiconductor laser, and accordingly, it serves as a constant current source. As a result, its output impedance is high.

The impedance control circuit 8 is adapted to match the output impedance of the laser current output circuit 7 with the characteristic impedance of the transmission line 2 connected to the laser drive signal output terminal 9 of the laser drive device 1 (LS1), and accordingly, it serves as a variable impedance element. The impedance control circuit 8 will be detailed later.

The interface circuit 15 receives a control signal from the system controller 14 in the optical disk device, by way of the system bus 16, and sets various setting values to the circuit block in the laser drive device 1 in accordance with the received data.

In general, a flexible print circuit board constitutes a microstrip line structure so as to be capable of carrying out impedance control for a transmission line. Accordingly, there may be designed such a configuration that the transmission line 2 is formed into a microstrip line structure for controlling the transmission impedance.

A semiconductor laser used in an optical disk device is in general solely enclosed in a metal can package. The semiconductor laser may be fixed to an optical pickup casing through the intermediary of a mechanism which can be finely adjusted in order to carry out optical positional adjustment. Further, since the semiconductor laser generates a heat due to its power consumption, heat radiation is required. Thus, the metal can package also utilizes a metal pickup casing as a heat radiator.

It is noted that metal can package as the outer sheath of the semiconductor laser is in general connected to either one of a cathode or an anode of the semiconductor laser. Thus, when a current path running through the semiconductor laser is connected at one end to the pickup casing, the transmission line for the laser drive current becomes electrically unbalanced.

Thus, as stated above, in the microstrip line design of the transmission line 2, the flexible print wiring substrate is, almost always, formed of not less than two layers, including a ground layer set near to the pickup casing, and a signal layer set remote from the pickup casing, and accordingly, it is possible to prevent occurrence of impedance variation caused by a change in the distance between the pickup casing which is grounded, and the signal layer.

Further, the signal layer preferably has such a structure that it is held between two ground layers in order to reduce the interference between the above-mentioned signal layer and a component other than the transmission line.

Next, explanation will be hereinbelow made of the impedance control circuit 8.

As stated above, the output impedance of the laser current output circuit 7 has to have a high impedance in view of its purposes. Further, the semiconductor laser 3 has an impedance which depends upon a package, a laser chip process, a structure or the like. However, these matters can hardly be changed from their present states, and accordingly, the impedances can hardly be changed, exceeding their present ranges.

Meanwhile, the impedance which can be taken from the transmission line 2 may be set in a range from about several ten to 100 ohms if it is constituted by a microstrip line, and in this range, it is controllable. Thus, in this case, the following method will be taken with the use of the impedance control circuit 8, in order to carry out impedance matching among three devices, such as, (1) the laser current output circuit 7, (2) the transmission line 2 and (3) semiconductor laser 3.

At first, the impedance of the transmission line 2 is designed so as to be approximately equal to that of the semiconductor laser 3. Next, in order to match the impedance of the transmission line 2 with the output impedance of the laser drive device 1, the impedance control circuit 8 is connected in series or parallel to the laser current output circuit 7 (cascade connection), and the impedance of the impedance control circuit 8 is controlled in such a way that the combined impedance between the laser current output circuit 7 and the impedance control circuit 8 is nearly equal to the impedance of the transmission line 2.

More specifically, the impedance control circuit 8 is set so as to increase the impedance of the impedance 8 when the combined impedance between the semiconductor laser 3 and the transmission line 2 is larger than that of the output impedance of the laser drive device 1 as viewed from the laser drive device 1, but it is set so as to decrease the impedance of the impedance 8 when the combined impedance between the semiconductor laser 3 and the transmission line 2 is smaller than the output impedance of the laser drive device 1 as viewed from the laser drive device 1, thereby it is possible to aim at making the impedance matching.

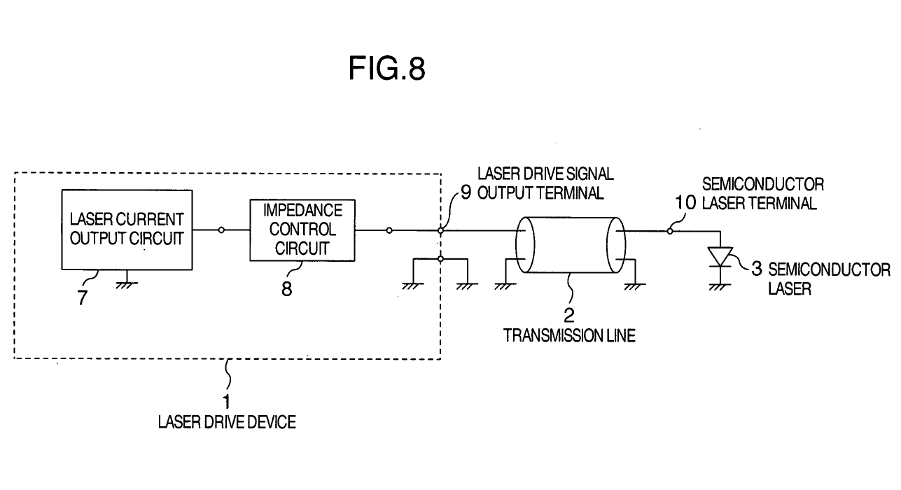

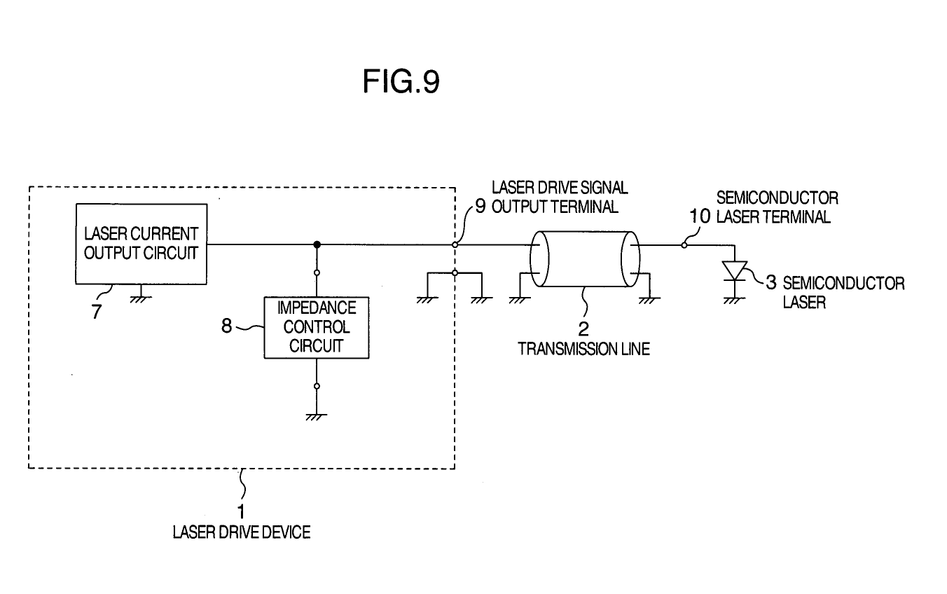

FIG. 8 shows such a case that the laser current output circuit 7 and the impedance control circuit 8 are connected in series to each other. Further, FIG. 9 shows such a case that the laser current output circuit 7 and the impedance control circuit 8 are connected in parallel with each other.

The laser current output circuit 7 and the impedance control circuit 8 are both arranged in an LSI package, and accordingly, both are apparently integrally incorporated with each other as viewed from the transmission line 2, and accordingly, the output impedance of the laser drive device 1 becomes nearly equal to the impedance of the transmission line 2. As a result, it is possible to reduce reflection and transmission loss between the laser drive device 1 and the transmission line 2.

Next, the configuration of the impedance control circuit 8 will be explained.

Referring to FIG. 5 which is a block diagram illustrating the configuration of the impedance control circuit 8.

The impedance control circuit 8 serves as a constant impedance source having an impedance which can be changed under control. Impedance matching is required in the frequency range in which frequencies of the laser modulation signal and the high frequency superposing signal are present, and no impedance matching is required in a d.c. (direct current) range. Thus, there may be used an impedance source having such a configuration that the d.c. range is cut off by, for example, a capacitor 11 shown in FIG. 5, and thereafter, a desired resistor is selected from a group 13 consisting of several resistors and is connected by a selector 12.

It is preferable, in view of high frequency characteristics, isolation, insertion loss, facility of mounting to an LSI and the like, to use a mechanical switch by MEMS (Micro Electro Mechanical System) or the like, as the selector 12. However, an analog switch by a semiconductor may be also used. As an example of the analog switch, there may be enumerated those by MOSFET (Metal Oxide Semiconductor Field-Effect Transistor), bipolar transistor, PIN-diode, and the like. Further, the change-over of the selector 12 may be controlled in such a way that a predetermined value is set in an interface circuit 15 in the laser drive device 1 (LSI) from a system controller 14 in the optical disk device by way of the system bus 16. Further, a resistor 21 is provided so as to appropriately change the impedance variation range of the impedance control circuit 8, and alternatively, the impedance of the impedance control circuit 8 may be controlled in a low frequency range cut off by the capacitor 11.

As stated above, the impedance matching from the laser drive device 1 to the semiconductor laser 3 is improved so as to reduce waveform distortion of the laser drive signal in order to aim at enhancing the recording quality, and further, the high frequency superposing power efficiency is improved so as to reduce the power consumption.

Although precise impedance matching is desirable, even in the case of impedance mismatching of about 2 times or 0.5 times, the return loss is practically 6 dB at most, and accordingly, a transmission power of 75% may be obtained. Thus, it is tolerable if the impedance matching may be controlled so that the impedance mismatching falls in a range from about 2 to 0.5 time.

Next, explanation will be hereinbelow made of a second embodiment of the present invention.

The configuration of the second embodiment is the same as that of the first embodiment, except that the configuration of the impedance control circuit is different, and accordingly, the different part will be hereinbelow explained while explanation to the same parts will be abbreviated.

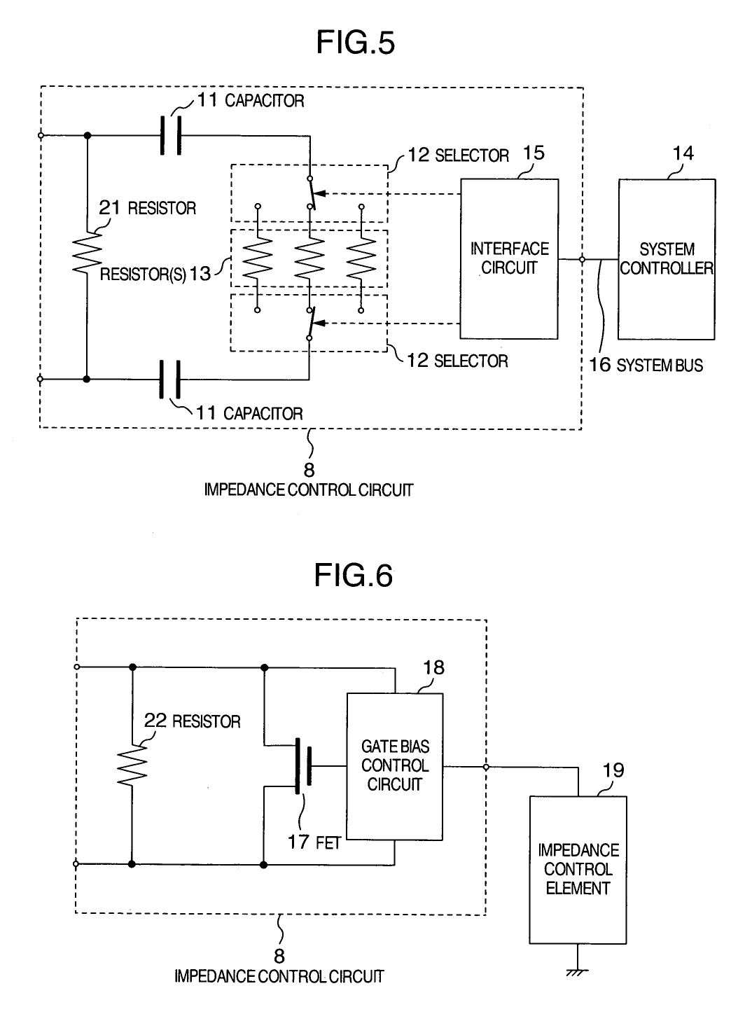

FIG. 6 is a block diagram illustrating a configuration of the impedance control circuit in the second embodiment of the present invention.

In this embodiment, a channel is used between a drain and a source of an FET as a constant impedance source which can be changed under control. In general, the channel of the FET serves as a constant current source if its gate bias is fixed, and accordingly, it has a high output impedance. Thus, a gate bias control circuit 18 for changing a gate bias in accordance with a voltage between the drain and source is designed in such a way that a current which is substantially in proportion to a voltage between the drain and the source is fed by the gate bias control circuit 18.

At this stage, the current running through the channel becomes substantially proportional to the voltage between the drain and the source, and as a result, the drain current and the voltage between the drain and the source are substantially proportional to each other, thereby it is possible to materialize the constant impedance (resistance) operation. Further, with such a configuration that a resistor 22 is added so as to constitute an parallel impedance circuit composed of an FET 17 and the resistor 22, the gate bias v.s. impedance sensitivity of the FET 17 may be decreased, and accordingly, the control may be facilitated in a practical impedance range.

Further, if the proportional coefficient between the drain-source voltage and the drain current is determined by an impedance control element 19 which is a circuit element externally connected to the impedance control circuit 8, the following features can be offered:

At first, with the configuration of the impedance control circuit 8, there may be obtained a technical effect peculiar to this embodiment, that is, the circuit configuration may be convenient in comparison with that of the first embodiment.

Further, in such a case that the impedance control element 19 is provided in the LSI which is the laser drive device 1, and the circuit constant of the impedance control element 19 can be selected by laser trimming, a specific impedance can be selected from a plurality of output impedances with the use of one and the same LSI mask, and accordingly, there may be exhibited such a feature that the maker can eliminate the necessity of provision of different masks for respective output impedances.

Further, in such a case that a plurality of the impedance control elements are provided in the LSI which is the laser drive device 1, and a desired one of them is designated by a set value from the interface circuit 15, there may be exhibited such a feature that the user can change the output impedance of the laser drive device 1 by way of the system controller 14.

Further, in such a case that the impedance control element 19 is provided, external of the laser drive device 1, and the laser drive device 1 is provided with a terminal which is adapted to be connected to the impedance control element 19 so as to allow the user to change the circuit constant of the impedance control element 19 to be connected, there may be exhibited such a feature that the user can set a desired output impedance.

It is clear that the impedance changing element in the impedance control circuit 8 may be constituted by any of those other than FET 17, such as a bipolar transistor.

It should be further understood by those skilled in the art that although the foregoing description has been made on embodiments of the invention, the invention is not limited thereto and various changes and modifications may be made without departing from the sprit of the invention and the scope of the appended claims.

1. An optical disk device comprising:
a semiconductor laser,
a laser drive device for driving the semiconductor laser,
a transmission line for feeding a power for driving the semiconductor laser, from the laser drive device, and
an impedance control circuit for controlling an output impedance of the laser drive device in accordance with an input impedance of the semiconductor laser and an impedance of the transmission line.

2. The optical disk device of claim 1, wherein the impedance control circuit comprises an interface circuit for controlling operation from a system control circuit in the optical disk device, and the output impedance of the laser drive device is controlled, depending upon a set value from the system control device to the interface circuit.

3. The optical disk device of claim 1, wherein the impedance control circuit is configured to change an impedance of the impedance control circuit depending upon a value of an electric circuit element to be connected and the output impedance of the laser drive device is controlled depending upon the value of the electric circuit element.

4. The optical disk device of claim 1, wherein the impedance control circuit is incorporated in the laser drive device.

5. The optical device of claim 1, wherein the laser drive device comprises a laser current output circuit for outputting a laser drive current, and the impedance control circuit, the laser current output circuit and the impedance control circuit are cascade-connected to each other, and the laser drive device comprises the impedance control circuit so that an impedance for driving the transmission line becomes a series impedance between the output impedance of the laser current output circuit and the impedance of the impedance control circuit.

6. The optical device of claim 1, wherein the laser drive device comprises a laser current output circuit for outputting a laser drive current, and the impedance control circuit, the laser current output circuit and the impedance control circuit are cascade-connected to each other, and the laser drive device comprises the impedance control circuit so that an impedance for driving the transmission line becomes a parallel impedance between the output impedance of the laser current output circuit and the impedance of the impedance control circuit.

7. The optical disk device of claim 5, further comprising an impedance of the transmission line which is 0.5 to 2 times as large as the impedance of the semiconductor laser, and
an impedance of the laser current output circuit which is lower than the impedance of the transmission line, and
wherein the impedance of the impedance control circuit is controlled so as to cause the combined impedance between the impedance of the laser current output circuit and the impedance of the impedance control circuit to become 0.5 to 2 times as large the impedance of the transmission line.

8. The optical disk device of claim 6, further comprising an impedance of the transmission line which is 0.5 to 2 times as large as the impedance of the semiconductor laser, and
an impedance of the laser current output circuit which is higher than the impedance of the transmission line, and
wherein the impedance of the impedance control circuit is controlled so as to cause the combined impedance between the impedance of the laser current output circuit and the impedance of the impedance control circuit to become 0.5 to 2 times as large the impedance of the transmission line.

9. The optical disk device of claim 1, wherein the transmission line forms a microstrip line so as to carry out an impedance control.

10. The optical disk device of claim 1, wherein the impedance control circuit increases the impedance of the impedance control circuit if a combined impedance between the semiconductor laser and the transmission line is larger than the output impedance of the laser drive device as viewed from the laser drive device, and
wherein the impedance control circuit decreases the impedance thereof if the combined impedance therebetween is smaller than the output impedance of the laser drive device, as viewed from the laser drive device.

11. An optical pickup device comprising:
a semiconductor laser,
a transmission line for feeding a power for driving the semiconductor laser, from a laser drive device, and
an impedance control circuit for controlling an output impedance of the laser drive device, depending upon an input impedance of the semiconductor laser and an impedance of the transmission line.

12. The optical pickup device of claim 11, wherein the transmission line forms a microstrip line so as to carry out an impedance control.

13. A semiconductor laser drive device for driving a semiconductor laser comprising:
an input impedance of the semiconductor laser,
an impedance control circuit for controlling an output impedance of the laser drive device, depending upon an impedance of a transmission line connecting the semiconductor laser with the laser drive device.

14. The semiconductor laser drive device of claim 13, wherein the impedance control circuit is adapted to change over a switch utilizing a MEMS (Micro Electro Mechanical system) so as to carry out an impedance control.
